(19) United States
(12) Patent Application Publication
(10) Pub. No.: US 2011/0178206 A1
(43) Pub. Date: Jul. 21, 2011

(54) FLAME RETARDANT POLY(TRIMETHYLENE TEREPHTHALATE) COMPOSITION

(75) Inventors: Jin-Chung Chang, Garnet Valley, PA (US); Yuanfeng Liang, Chadds Ford, PA (US); Joseph P. Mckeown, Wilmington, DE (US); Matthew Arthur Page, Wilmington, DE (US)

(73) Assignee: E,I DU PONT DE NEMOURS AND COMPANY, Wilmington, DE (US)

(21) Appl. No.: 13/122,046

(22) PCT Filed: Oct. 13, 2009
(86) PCT No.: PCT/US09/60461

§ 371 Date: Mar. 31, 2011

Related U.S. Application Data
(62) Division of application No. 61/105,824, filed on Oct. 16, 2008.

(51) Int. Cl. C08K 5/523; C08J 3/22; C08L 67/02

(52) U.S. Cl. 523/351; 524/127

(57) ABSTRACT

Improved flame retardant polytrimethylene terephthalate compositions are provided by including a bis(diphenyl phosphate) flame retardant additive.

### FIELD OF THE INVENTION

The present invention relates to flame retardant poly(trimethylene terephthalate) compositions comprising certain bis(diphenyl phosphate) compounds as flame retardant additives.

### BACKGROUND

Poly(trimethylene terephthalate) (“PTT”) is generally prepared by the polycondensation reaction of 1,3-propanediol with terephthalic acid or terephthalic acid esters. Poly(trimethylene terephthalate) polymer, when compared to poly(ethylene terephthalate) (“PET”, made with ethylene glycol as opposed to 1,3-propane diol) or poly(butylene terephthalate) (“PBT”, made with 1,4-butane diol as opposed to 1,3-propane diol), is superior in mechanical characteristics, weatherability, heat aging resistance and hydrolysis resistance.

Poly(trimethylene terephthalate), poly(ethylene terephthalate) and poly(butylene terephthalate) find use in many application areas (such as carpets, home furnishings, automotive parts and electronic parts) that require a certain level of flame retardance. It is known that poly(trimethylene terephthalate) in and of itself may, under certain circumstances, have insufficient flame retardance, which currently limits in many of these application areas.

There have been several attempts to improve the flame retardance properties of poly(trimethylene terephthalate) compositions through the addition of various flame retardant additives. For example, poly(trimethylene terephthalate) compositions containing halogen-type flame retardants have been widely studied. For example, GB1473369 discloses a polymer composition containing poly(propylene terephthalate) or poly(butylene terephthalate), decabromodiphenyl ether, antimony trioxide and asbestos. U.S. Pat. No. 4,131,594 discloses a polymer composition containing poly(trimethylene terephthalate) and a graft copolymer halogen-type flame retardant, such as a polycarbonate oligomer of decabromobiphenyl ether or tetrabromobisphenol A, antimony oxide and glass fiber.

Japanese Patent Publication 2003-292574 discloses the flame retardant compositions containing poly(trimethylene terephthalate) polymer, fire retardants selected from derivatives of phosphate, phosphazene, phosphine and phosphine oxide, as well as fire resistant materials containing nitrogen-containing derivatives including melamine, cyanuric acid, isocyanuric acid, ammonia and the like.

There still is a need to provide poly(trimethylene terephthalate) compositions with improved flame retardancy properties. The present invention fulfills such need.

### SUMMARY OF THE INVENTION

The invention is directed to a poly(trimethylene terephthalate)-based composition comprising: (a) from about 75 to about 99.9 wt % of a polymer component wherein the wt % of the polymer component is based on the total composition comprising at least about 70 wt % of a poly(trimethylene terephthalate) wherein the wt % is based on the polymer component, and (b) from about 0.1 to about 25 wt % of an additive package based on the total composition wherein the additive package comprises from about 0.1 to about 15 wt % of bis-phenol A-bis(diphenyl phosphate) wherein the wt % of the polymer component is based on the total composition with the proviso that the bis-phenol A-bis(diphenyl phosphate) does not contain nitrogen.

The invention is further directed to a process for preparing a poly(trimethylene terephthalate)-based composition, comprising the steps of:

a) providing (1) bis-phenol A-bis(diphenyl phosphate) with the proviso that the bis-phenol A-bis(diphenyl phosphate) does not contain nitrogen; and (2) polytrimethylene terephthalate;

b) mixing the polytrimethylene terephthalate and the bis-phenol A-bis(diphenyl phosphate to form a mixture; and

c) heating and blending the mixture with agitation to form the composition.

### DETAILED DESCRIPTION

### Polymer Component

The present invention provides a poly(trimethylene terephthalate)-based composition comprising: (a) from about 75 to about 99.9 wt % of a polymer component (based on the total composition weight) comprising at least about 70 wt % poly(trimethylene terephthalate) (based on the weight of the polymer component), and (b) from about 0.1 to about 25 wt % of an additive package (based on the total composition weight), wherein the additive package comprises from about 0.1 to about 15 wt % of a bis(diphenyl phosphate) compound as a flame retardant additive (based on the total composition weight).

The poly(trimethylene terephthalate) is of the type made by polycondensation of terephthalic acid or acid equivalent and 1,3-propanediol, with the 1,3-propane diol preferably being of the type that is obtained biochemically from a renewable source (“biologically-derived” 1,3-propanediol).

As indicated above, the polymer component (and composition as a whole) comprises a predominant amount of a poly(trimethylene terephthalate).

Poly(trimethylene terephthalate) suitable for use in the invention are well known in the art, and conveniently prepared by polycondensation of 1,3-propane diol with terephthalic acid or terephthalic acid equivalent.

By “terephthalic acid equivalent” is meant compounds that perform substantially like terephthalic acids in reaction with polymeric glycols and diols, as would be generally recognized by a person of ordinary skill in the relevant art. Terephthalic acid equivalents for the purpose of the present invention include, for example, esters (such as dimethyl terephthalate), and ester-forming derivatives such as acid halides (e.g., acid chlorides) and anhydrides.

Preferred are terephthalic acid and terephthalic acid esters, more preferably the dimethyl ester. Methods for preparation of poly(trimethylene terephthalate) are discussed, for example in U.S. Pat. No. 6,277,947, U.S. Pat. No. 6,326,456, U.S. Pat. No. 6,657,044, U.S. Pat. No. 6,353,062, U.S. Pat. No. 6,538,076, US2003/0220465A1 and commonly owned U.S. patent application Ser. No. 11/638919 (filed 14 Dec. 2006, entitled “Continuous Process for Producing Poly(trimethylene Terephthalate)”).

The 1,3-propanediol for use in making the poly(trimethylene terephthalate) is preferably obtained biochemically from a renewable source (“biologically-derived” 1,3-propanediol).

A particularly preferred source of 1,3-propanediol is via a fermentation process using a renewable biological source. As an illustrative example of a starting material from a renewable source, biochemical routes to 1,3-propanediol (PDO) have been described that utilize feedstocks produced from biological and renewable resources such as corn feed stock. For example, bacterial strains able to convert glycerol into 1,3-propanediol are found in the species Klebsiella, Citrobacter, Clostridium, and Lactobacillus. The technique is disclosed in several publications, including previously incorporated U.S. Pat. No. 5,633,362, U.S. Pat. No. 5,686,276 and U.S. Pat. No. 5,821,092. U.S. Pat. No. 5,821,092 discloses, inter alia, a process for the biological production of 1,3-propanediol from glycerol using recombinant organisms. The process incorporates E. coli bacteria, transformed with a heterologous pdu diol dehydratase gene, having specificity for 1,2-propanediol. The transformed E. coli is grown in the presence of glycerol as a carbon source and 1,3-propanediol is isolated from the growth media. Since both bacteria and yeasts can convert glucose (e.g., corn sugar) or other carbohydrates to glycerol, the processes disclosed in these publications provide a rapid, inexpensive and environmentally responsible source of 1,3-propanediol monomer.

The biologically-derived 1,3-propanediol, such as produced by the processes described and referenced above, contains carbon from the atmospheric carbon dioxide incorporated by plants, which compose the feedstock for the production of the 1,3-propanediol. In this way, the biologically-derived 1,3-propanediol preferred for use in the context of the present invention contains only renewable carbon, and not fossil fuel-based or petroleum-based carbon. The polytrimethylene terephthalate based thereon utilizing the biologically-derived 1,3-propanediol, therefore, has less impact on the environment as the 1,3-propanediol used does not deplete diminishing fossil fuels and, upon degradation, releases carbon back to the atmosphere for use by plants once again. Thus, the compositions of the present invention can be characterized as more natural and having less environmental impact than similar compositions comprising petroleum based diols.

The biologically-derived 1,3-propanediol, and polytrimethylene terephthalate based thereon, may be distinguished from similar compounds produced from a petrochemical source or from fossil fuel carbon by dual carbon-isotopic finger printing. This method usefully distinguishes chemically-identical materials, and apportions carbon material by source (and possibly year) of growth of the biospheric (plant) component. The isotopes, ¹⁴C and ¹³C, bring complementary information to this problem. The radiocarbon dating isotope (¹⁴C), with its nuclear half life of 5730 years, clearly allows one to apportion specimen carbon between fossil (“dead”) and biospheric (“alive”) feedstocks (Currie, L. A. “Source Apportionment of Atmospheric Particles,” Characterization of Environmental Particles, J. Buffle and H. P. van Leeuwen, Eds., 1 of Vol. I of the IUPAC Environmental Analytical Chemistry Series (Lewis Publishers, Inc) (1992) 3-74). The basic assumption in radiocarbon dating is that the constancy of ¹⁴C concentration in the atmosphere leads to the constancy of ¹⁴C in living organisms. When dealing with an isolated sample, the age of a sample can be deduced approximately by the relationship:

t=(−5730/0.693)In(A/A₀)

wherein t=age, 5730 years is the half-life of radiocarbon, and A and A₀ are the specific ¹⁴C activity of the sample and of the modern standard, respectively (Hsieh, Y., Soil Sci. Soc. Am J., 56, 460, (1992)). However, because of atmospheric nuclear testing since 1950 and the burning of fossil fuel since 1850, ¹⁴C has acquired a second, geochemical time characteristic. Its concentration in atmospheric CO₂, and hence in the living biosphere, approximately doubled at the peak of nuclear testing, in the mid-1960s. It has since been gradually returning to the steady-state cosmogenic (atmospheric) baseline isotope rate (¹⁴C/¹²C) of ca. 1.2×10⁻¹², with an approximate relaxation “half-life” of 7-10 years. (This latter half-life must not be taken literally; rather, one must use the detailed atmospheric nuclear input/decay function to trace the variation of atmospheric and biospheric ¹⁴C since the onset of the nuclear age.) It is this latter biospheric ¹⁴C time characteristic that holds out the promise of annual dating of recent biospheric carbon. ¹⁴C can be measured by accelerator mass spectrometry (AMS), with results given in units of “fraction of modern carbon” (f_{M}). f_{M} is defined by National Institute of Standards and Technology (NIST) Standard Reference Materials (SRMs) 4990B and 4990C, known as oxalic acids standards HOxI and HOxII, respectively. The fundamental definition relates to 0.95 times the ¹⁴C/¹²C isotope ratio HOxI (referenced to AD 1950). This is roughly equivalent to decay-corrected pre-Industrial Revolution wood. For the current living biosphere (plant material), f_{M}˜1.1.

The stable carbon isotope ratio (¹³C/¹²C) provides a complementary route to source discrimination and apportionment. The ¹³C/¹²C ratio in a given biosourced material is a consequence of the ¹³C/¹²C ratio in atmospheric carbon dioxide at the time the carbon dioxide is fixed and also reflects the precise metabolic pathway. Regional variations also occur. Petroleum, C₃ plants (the broadleaf), C₄ plants (the grasses), and marine carbonates all show significant differences in ¹³C/¹²C and the corresponding δ¹³C values. Furthermore, lipid matter of C₃ and C₄ plants analyze differently than materials derived from the carbohydrate components of the same plants as a consequence of the metabolic pathway. Within the precision of measurement, ¹³C shows large variations due to isotopic fractionation effects, the most significant of which for the instant invention is the photosynthetic mechanism. The major cause of differences in the carbon isotope ratio in plants is closely associated with differences in the pathway of photosynthetic carbon metabolism in the plants, particularly the reaction occurring during the primary carboxylation, i.e., the initial fixation of atmospheric CO₂. Two large classes of vegetation are those that incorporate the “C₃” (or Calvin-Benson) photosynthetic cycle and those that incorporate the “C₄” (or Hatch-Slack) photosynthetic cycle. C₃ plants, such as hardwoods and conifers, are dominant in the temperate climate zones. In C₃ plants, the primary CO₂ fixation or carboxylation reaction involves the enzyme ribulose-1,5-diphosphate carboxylase and the first stable product is a 3-carbon compound. C₄ plants, on the other hand, include such plants as tropical grasses, corn and sugar cane. In C₄ plants, an additional carboxylation reaction involving another enzyme, phosphenol-pyruvate carboxylase, is the primary carboxylation reaction. The first stable carbon compound is a 4-carbon acid, which is subsequently decarboxylated. The CO₂ thus released is refixed by the C₃ cycle.

Both C₄ and C₃ plants exhibit a range of ¹³C/¹²C isotopic ratios, but typical values are ca. −10 to −14 per mil (C₄) and −21 to −26 per mil (C₃) (Weber et al., J. Agric. Food Chem., 45, 2942 (1997)). Coal and petroleum fall generally in this latter range. The ¹³C measurement scale was originally defined by a zero set by pee dee belemnite (PDB) limestone, where values are given in parts per thousand deviations from this material. The “δ¹³C” values are in parts per thousand (per mil), abbreviated ‰, and are calculated as follows:

$${δ}^{13} C ≡ \frac{{(}^{13} C {/}^{12} C ) sample - {(}^{13} C {/}^{12} C ) standard}{{(}^{13} C {/}^{12} C ) standard} \times 1000 \% o$$

Since the PDB reference material (RM) has been exhausted, a series of alternative RMs have been developed in cooperation with the IAEA, USGS, NIST, and other selected international isotope laboratories. Notations for the per mil deviations from PDB is δ¹³C. Measurements are made on CO₂ by high precision stable ratio mass spectrometry (IRMS) on molecular ions of masses 44, 45 and 46.

Biologically-derived 1,3-propanediol, and compositions comprising biologically-derived 1,3-propanediol, therefore, may be completely distinguished from their petrochemical derived counterparts on the basis of ¹⁴C (f_{M}) and dual carbon-isotopic fingerprinting, indicating new compositions of matter. The ability to distinguish these products is beneficial in tracking these materials in commerce. For example, products comprising both “new” and “old” carbon isotope profiles may be distinguished from products made only of “old” materials. Hence, the instant materials may be followed in commerce on the basis of their unique profile and for the purposes of defining competition, for determining shelf life, and especially for assessing environmental impact.

Preferably the 1,3-propanediol used as a reactant or as a component of the reactant in making poly(trimethylene terephthalate) will have a purity of greater than about 99%, and more preferably greater than about 99.9%, by weight as determined by gas chromatographic analysis. Particularly preferred are the purified 1,3-propanediols as disclosed in U.S. Pat. No. 7,038,092, U.S. Pat. No. 7,098,368, U.S. Pat. No. 7,084,311 and US20050069997A1.

The purified 1,3-propanediol preferably has the following characteristics:

(1) an ultraviolet absorption at 220 nm of less than about 0.200, and at 250 nm of less than about 0.075, and at 275 nm of less than about 0.075; and/or

(2) a composition having a CIELAB “b*” color value of less than about 0.15 (ASTM D6290), and an absorbance at 270 nm of less than about 0.075; and/or

(3) a peroxide composition of less than about 10 ppm; and/or

(4) a concentration of total organic impurities (organic compounds other than 1,3-propanediol) of less than about 400 ppm, more preferably less than about 300 ppm, and still more preferably less than about 150 ppm, as measured by gas chromatography.

Poly(trimethylene terephthalate)s useful in this invention can be poly(trimethylene terephthalate) homopolymers (derived substantially from 1,3-propane diol and terephthalic acid and/or equivalent) and copolymers, by themselves or in blends. Poly(trimethylene terephthalate)s used in the invention preferably contain about 70 mole % or more of repeat units derived from 1,3-propane diol and terephthalic acid (and/or an equivalent thereof, such as dimethyl terephthalate).

The poly(trimethylene terephthalate) may contain up to 30 mole % of repeat units made from other diols or diacids. The other diacids include, for example, isophthalic acid, 1,4-cyclohexane dicarboxylic acid, 2,6-naphthalene dicarboxylic acid, 1,3-cyclohexane dicarboxylic acid, succinic acid, glutaric acid, adipic acid, sebacic acid, 1,12-dodecane dioic acid, and the derivatives thereof such as the dimethyl, diethyl, or dipropyl esters of these dicarboxylic acids. The other diols include ethylene glycol, 1,4-butane diol, 1,2-propanediol, diethylene glycol, triethylene glycol, 1,3-butane diol, 1,5-pentane diol, 1,6-hexane diol, 1,2-, 1,3- and 1,4-cyclohexane dimethanol, and the longer chain diols and polyols made by the reaction product of diols or polyols with alkylene oxides.

Poly(trimethylene terephthalate) polymers useful in the present invention may also include functional monomers, for example, up to about 5 mole % of sulfonate compounds useful for imparting cationic dyeability. Specific examples of preferred sulfonate compounds include 5-lithium sulfoisophthalate, 5-sodium sulfoisophthalate, 5-potassium sulfoisophthalate, 4-sodium sulfo-2,6-naphthalenedicarboxylate, tetramethylphosphonium 3,5-dicarboxybenzene sulfonate, tetrabutylphosphonium 3,5-dicarboxybenzene sulfonate, tributyl-methylphosphonium 3,5-dicarboxybenzene sulfonate, tetrabutylphosphonium 2,6-dicarboxynaphthalene-4-sulfonate, tetramethylphosphonium 2,6-dicarboxynapthalene-4-sulfonate, ammonium 3,5-dicarboxybenzene sulfonate, and ester derivatives thereof such as methyl, dimethyl, and the like.

More preferably, the poly(trimethylene terephthalate)s contain at least about 80 mole %, or at least about 90 mole %, or at least about 95 mole %, or at least about 99 mole %, of repeat units derived from 1,3-propane diol and terephthalic acid (or equivalent). The most preferred polymer is poly(trimethylene terephthalate) homopolymer (polymer of substantially only 1,3-propane diol and terephthalic acid or equivalent).

The polymer component may contain other polymers blended with the poly(trimethylene terephthalate) such as poly(ethylene terephthalate) (PET), poly(butylene terephthalate) (PBT), a nylon such nylon-6 and/or nylon-6,6, etc., and preferably contains at least about 70 wt %, or at least about 80 wt %, or at least about 90 wt %, or at least about 95 wt %, or at least about 99 wt %, poly(trimethylene terephthalate) based on the weight of the polymer component. In one preferred embodiment, poly(trimethylene terephthalate) is used without such other polymers.

### Additive Package

The poly(trimethylene terephthalate)-based compositions of the present invention may contain additives such as antioxidants, residual catalyst, delusterants (such as TiO₂, zinc sulfide or zinc oxide), colorants (such as dyes), stabilizers, fillers (such as calcium carbonate), antimicrobial agents, antistatic agents, optical brighteners, extenders, processing aids and other functional additives, hereinafter referred to as “chip additives”. When used, TiO₂ or similar compounds (such as zinc sulfide and zinc oxide) are used as pigments or delusterants in amounts normally used in making poly(trimethylene terephthalate) compositions, that is up to about 5 wt % or more (based on total composition weight) in making fibers and larger amounts in some other end uses. When used in polymer for fibers and films, TiO₂ is added in an amount of preferably at least about 0.01 wt %, more preferably at least about 0.02 wt %, and preferably up to about 5 wt %, more preferably up to about 3 wt %, and most preferably up to about 2 wt % (based on total composition weight).

By “pigment” reference is made to those substances commonly referred to as pigments in the art. Pigments are substances, usually in the form of a dry powder, that impart color to the polymer or article (e.g., chip or fiber). Pigments can be inorganic or organic, and can be natural or synthetic. Generally, pigments are inert (e.g., electronically neutral and do not react with the polymer) and are insoluble or relatively insoluble in the medium to which they are added, in this case the poly(trimethylene terephthalate) composition. In some instances they can be soluble.

A bis(diphenyl phosphate) flame retardant additive is used in the compositions of the disclosed embodiments. An examples of such a material includes bis-phenol A-bis(diphenyl phosphate).

The bis-phenol A-bis(phenyl phosphate) may be mixed with other flame retardant additive materials, and thus may also be suitable for the disclosed embodiments. However, for the present embodiments, bis-phenol A-bis(phenyl phosphate) and other flame retardant additive materials exclude nitrogen.

The invention also relates to a process for preparing a poly(trimethylene terephthalate) composition with improved flame retardancy, comprising the steps of:

a) providing (1) bis-phenol A-bis(diphenyl phosphate) with the proviso that the bis-phenol A-bis(diphenyl phosphate) does not contain nitrogen; and (2) poly(trimethylene terephthalate);

b) mixing the poly(trimethylene terephthalate) and the bis-phenol A-bis(diphenyl phosphate) to form a mixture; and

c) heating and blending the mixture with agitation to form the composition.

The poly(trimethylene terephthalate)-based compositions of the invention may be prepared by conventional blending techniques well known to those skilled in the art, e.g. compounding in a polymer extruder, melt blending, etc.

When the polymer component and flame retardant additive(s) are melt blended. More specifically they are mixed and heated at a temperature sufficient to form a melt blend, and spun into fibers or formed into shaped articles, preferably in a continuous manner. The ingredients can be formed into a blended composition in many different ways. For instance, they can be (a) heated and mixed simultaneously, (b) pre-mixed in a separate apparatus before heating, or (c) heated and then mixed. The mixing, heating and forming can be carried out by conventional equipment designed for that purpose such as extruders, Banbury mixers or the like. The temperature should be above the melting points of each component but below the lowest decomposition temperature, and accordingly must be adjusted for any particular composition of PTT and flame retardant additive. The temperature is typically in the range of about 180° C. to about 270° C.

When the flame retardant additive(s) is a liquid, it can be added to the polymer component via liquid injection. Generally, this can be accomplished by using a syringe pump (e.g., Isco Syringe Pump, Model 1000D, Isco, Lincoln, Nebr.). The pressure used for injection is generally chosen to facilitate smooth addition of the additive to the polymer.

The amount of flame retardant additive utilized is preferably from about 0.1 to about 15 wt %, based on total composition weight. More preferably, the amount is from about 0.5 to about 10 wt %, and still more preferably from about 2 to about 6 wt %, based on total composition weight.

### Uses

Another aspect of the invention relates to articles and fibers comprising the poly(trimethylene terephthalate) composition, such articles having improved flame retardant properties.

The poly(trimethylene terephthalate)-based compositions of this invention is useful in fibers, fabrics, films and other useful articles, and methods of making such compositions and articles, as disclosed in a number of the previously cited references. They may be used, for example, for producing continuous and cut (e.g., staple) fibers, yarns, and knitted, woven and nonwoven textiles. The fibers may be monocomponent fibers or multicomponent (e.g., bicomponent) fibers, and may have many different shapes and forms. They are useful for textiles and flooring.

A particularly preferred end use of the poly(trimethylene terephthalate)-based compositions of the invention is in the making of fibers for carpets, such as disclosed in U.S. Pat. No. 7,013,628.

### EXAMPLES

In the following examples, all parts, percentages, etc., are by weight unless otherwise indicated.

### Ingredients

The poly(trimethylene terephthalate) used in the examples was SORONA® “semi-bright” polymer available from E.I. du Pont de Nemours and Company (Wilmington, Del.).

The flame retardant additives utilized in the examples are described in Table 1 below.

TABLE 1

| Chemical Name | Trade Name | Supplier |
|---|---|---|
| Poly(trimethylene | Sorona ® | DuPont |
| terephthalate) | | Wilmington, DE |
| Bis-phenol A-bis(diphenyl | Fyrolflex BDP | Supresta |
| phosphate) (BDP) | | Ardsley, NY |

The approach to demonstrating flammability improvement was to (1) compound the flame retardant additive into the poly(trimethylene terephthalate), (2) cast a film of the modified poly(trimethylene terephthalate), and (3) test the flammability of the film to determine the flammability improvement with the flame retardant additive.

### Flame Retardant Additive Compounding

SORONA® polymer was dried in a vacuum oven at 120° C. for 16 hours, and flame retardant additive was also dried in a vacuum oven at 80° C. for 16 hours.

Dry polymer was fed at a rate of 20 pounds/hour to the throat of a W & P 30A twin screw extruder (MJM #4, 30 mm screw) with a temperature profile of 190° C. at the first zone to 250° C. at the screw tip and at the one hole strand die (4.76 mm diameter). Using an injection pump, the liquid flame retardant additive was fed to the second zone of the extruder which has a total of 8 zones, at a rate needed to achieve the specified concentration in the polymer, for example, at a rate of 2 pounds/hour to get a 10% loading into polymer. The throat of the extruder was purged with dry nitrogen gas during operation to minimize polymer degradation. The extrusion system was purged with dry polymer for >3 minutes prior to introduction of each flame retardant additive. Unmodified polymer or compounded polymer strand from the 4.76 mm die was cut into pellets for further processing into film.

### Film Preparation

All samples were dried at 120° C. for 16 hours before use in preparing films.

Unmodified SORONA® polymer and compounded SORONA® polymer samples were fed to the throat of a W & P 28D twin screw extruder (MGW #3, 28 mm screw). The extruder throat was purged with dry nitrogen during operation to minimize degradation. Zone temperatures ranged from 200° C. at the first zone to 240° C. at the screw tip with a screw speed of 100 rpm. Molten polymer was delivered to the film die, 254 mm wide×4 mm height, to produce a 4 mm thick film, 254 mm wide and up to about 18 meters long. The extruder system was purged with unmodified SORONA® polymer for at least 5 minutes prior to film preparation with each compounded test item.

### Test Sample Preparation

For each test item ten test specimens were press cut from the 4 mm thick film using a 51 mm×152 mm die. Five specimens were cut in the film longitudinal (extrusion) direction and five specimens were cut in the transverse (perpendicular to extrusion) direction. Test film specimens were oven dried at 105° C. for greater than 30 minutes followed by cooling in a desiccator for greater than 15 minutes before testing.

### Film Flammability Test

A film specimen, 51 mm×152 mm×4 mm, obtained as described above was held at an angle of 45°. A butane flame, 19 mm in length, was applied to the lower, 51-mm width, edge of the film until ignition occurred. After the flame self extinguished, the percent of the film specimen which burned or disappeared was determined and was recorded as percent consumed. The lower the percent consumed result the better the flame retardancy of the additive.

### Comparative Example A

Sorona® poly(trimethylene terephthalate) film with no flame-retardant additive was prepared and tested as described above.

Table 1 gives the results of film flammability testing. Each compounded polymer test item and control were tested five times longitudinally and transversely and the average given in Table 1. All of the flame-retardant containing items above showed improvement in this test versus control (Sorona® polymer). The ignition time for each test was 1 second.

TABLE 1

| | Sample | |
|---|---|---|
| Ex. | Designation | % Consumed |
| A | Sorona ® | 94 |
| 1 | Sorona ®/ | 75 |
| | BDP(3%) | |
| 2 | Sorona ®/ | 91 |
| | BDP(6%) | |
| 3 | Sorona ®/ | 92 |
| | BDP(0.7%) | |
| 4 | Sorona ®/ | 84 |
| | BDP(1.5%) | |

What is claimed is:

1. A poly(trimethylene terephthalate)-based composition comprising: (a) from about 75 to about 99.9 wt % of a polymer component wherein the wt % of the polymer component is based on the total composition comprising at least about 70 wt % of a poly(trimethylene terephthalate) wherein the wt % is based on the polymer component, and (b) from about 0.1 to about 25 wt % of an additive package based on the total composition wherein the additive package comprises from about 0.1 to about 15 wt % of bis-phenol A-bis(diphenyl phosphate) wherein the wt % of the polymer component is based on the total composition with the proviso that the bis-phenol A-bis(diphenyl phosphate) does not contain nitrogen.

2. The poly(trimethylene terephthalate)-based composition of claim 1, wherein the additive package comprises from about 0.5 to about 10 wt % of bis-phenol A-bis(diphenyl phosphate) wherein the weight % is based on total composition.

3. The poly(trimethylene terephthalate)-based composition of claim 1, wherein the additive package comprises from about 2 to about 6 wt % of bis-phenol A-bis(diphenyl phosphate wherein the weight % is based on total composition.

4. The poly(trimethylene terephthalate)-based composition of claim 1, wherein the poly(trimethylene terephthalate) is of the type made by polycondensation of terephthalic acid or acid equivalent and 1,3-propanediol.

5. The polytrimethylene terephthalate-based composition of claim 4, wherein the 1,3-propanediol is derived from a renewable source.

6. The poly(trimethylene terephthalate)-based composition of claim 1, wherein the poly(trimethylene terephthalate) is a poly(trimethylene phthalate) homopolymer.

7. The poly(trimethylene terephthalate)-based composition of claim 1, wherein the polymer component comprises an additional polymer.

8. The poly(trimethylene terephthalate)-based composition of claim 7, wherein the polymer component comprises a poly(ethylene terephthalate).

9. The poly(trimethylene terephthalate)-based composition of claim 7, wherein the polymer component comprises a poly(butylene terephthalate).

10. The poly(trimethylene terephthalate)-based composition of claim 7, wherein the polymer component comprises a nylon.

11. The poly(trimethylene terephthalate)-based composition of claim 1, wherein the additive package comprises a TiO₂.

12. The poly(trimethylene terephthalate)-based composition of claim 1, wherein the additive package further comprises one or more additional flame retardant additive materials with the proviso that the flame retardant materials do not contain nitrogen.

13. A process for preparing a poly(trimethylene terephthalate)-based composition, comprising the steps of:
a) providing (1) bis-phenol A-bis(diphenyl phosphate) with the proviso that the bis-phenol A-bis(diphenyl phosphate) does not contain nitrogen; and (2) polytrimethylene terephthalate;
b) mixing the polytrimethylene terephthalate and the bis-phenol A-bis(diphenyl phosphate to form a mixture; and
c) heating and blending the mixture with agitation to form the composition.

14. The process of claim 13, wherein step (c) occurs at about 180° C. to about 270° C.

15. An article made from the polytrimethylene terephthalate-based composition of claim 1.

16. The article of claim 15 wherein the polytrimethylene terephthalate-based composition of claim 1 is in the form of a fiber.
